(19) United States
(12) Patent Application Publication
(10) Pub. No.: US 2026/0155517 A1
(43) Pub. Date: Jun. 4, 2026

(54) BATTERY FRAME STRUCTURE

(71) Applicant: TOYOTA JIDOSHA KABUSHIKI KAISHA, Toyota-shi (JP)

(72) Inventor: Koji SAEKI, Okazaki-shi (JP)

(73) Assignee: TOYOTA JIDOSHA KABUSHIKI KAISHA, Toyota-shi (JP)

(21) Appl. No.: 19/383,831

(22) Filed: Nov. 10, 2025

(30) Foreign Application Priority Data
Dec. 4, 2024 (JP) 2024-211821

(51) Int. Cl. H01M 50/249; B60K 1/04; B60L 50/60; B60L 50/71

(52) U.S. Cl. CPC H01M 50/249; B60K 1/04; B60L 50/66; B60L 50/71

(57) ABSTRACT

A battery frame structure includes: right and left first skeleton members extending in a front-rear direction on both sides of a battery in a width direction, having a closed cross-sectional shape orthogonal to a longitudinal direction, and including a partition wall that separates an upper space and a lower space in a up-down direction; front and rear second skeleton members extending in the width direction on both sides of the battery in the front-rear direction, having a closed cross-sectional shape orthogonal to a longitudinal direction, and disposed on a vehicle front side or a vehicle rear side of the battery to be joined to a vehicle body structure; and corner retainers each including a first piece and a second piece, and fixed with the first piece put into the lower space and with the second piece put into an end portion of the second skeleton members in the longitudinal direction.

### CROSS-REFERENCE TO RELATED APPLICATION

This application claims priority to Japanese Patent Application No. 2024-211821 filed on Dec. 4, 2024. The disclosure of the above-identified application, including the specification, drawings, and claims, is incorporated by reference herein in its entirety.

### BACKGROUND

### 1. Technical Field

The present disclosure relates to a battery frame structure.

### 2. Description of Related Art

Japanese Unexamined Patent Application Publication No. 2007-39004 (JP 2007-39004 A) discloses a fuel cell electric vehicle in which a fuel cell is mounted under a floor panel of the vehicle via a battery frame.

### SUMMARY

The battery frame to which the fuel cell is mounted includes a pair of side frames extending in the vehicle front-rear direction on both sides in the vehicle width direction, and a cross frame that extends between the side frames. The side frames and the cross frame are joined by welding, an adhesive, or the like, by way of example. Therefore, it is difficult to achieve precision in the dimensions of the battery frame in the vehicle width direction, which results in variations in product dimensions. When there are variations in product dimensions, a gap or interference may occur when connecting a vehicle body structure that constitutes the skeleton of the vehicle and the battery frame, making assembly difficult, and it is desired to improve precision.

The present disclosure has been made in view of the above circumstances, and has an object to provide a battery frame structure that makes it easier to assemble a vehicle body structure and a battery frame.

A first aspect of the present disclosure provides a battery frame structure including: a pair of right and left first skeleton members that extends in a vehicle front-rear direction on both sides, in a vehicle width direction, of a battery for driving mounted on a vehicle, that has a closed cross-sectional shape orthogonal to a longitudinal direction, and that includes a partition wall that separates an upper space and a lower space in a vehicle up-down direction; a pair of front and rear second skeleton members that extends in the vehicle width direction on both sides of the battery in the vehicle front-rear direction, that has a closed cross-sectional shape orthogonal to a longitudinal direction, and that is disposed on a vehicle front side or a vehicle rear side of the battery to be joined to a vehicle body structure that constitutes a vehicle body skeleton; and corner retainers that each include a first piece and a second piece, and that are fixed with the first piece put into the lower space and with the second piece put into an end portion of the second skeleton members in the longitudinal direction.

In the battery frame structure according to the first aspect of the present disclosure, the vehicle width direction of the right and left first skeleton members can be aligned with surfaces of the vehicle body structure in the vehicle width direction by adjusting the fixed positions of the corner retainers and the second skeleton members. In addition, by inserting the corner retainers into the lower space of the first skeleton members, a step can be formed between the second skeleton members and the first skeleton members, and the vehicle body structure can be joined while being aligned with the step. In this manner, in the battery frame structure according to the first aspect of the present disclosure, the dimensions of the right and left first skeleton members in the vehicle width direction can be adjusted, and a step with which the vehicle body structure is aligned to be joined is formed, making it easier to assemble the vehicle body structure and the battery frame.

A second aspect of the present disclosure provides the battery frame structure according to the first aspect, in which: the corner retainers include first corner retainers that are used to connect the second skeleton member disposed on the vehicle front side and the first skeleton members, and second corner retainers that are used to connect the second skeleton member disposed on the vehicle rear side and the first skeleton members; and the first corner retainers and the second skeleton member, and the second corner retainers and the second skeleton member, are fixed by a distal end portion of the second piece.

In the battery frame structure according to the second aspect of the present disclosure, the first corner retainers, the second corner retainers, and the second skeleton members are each fixed by the distal end portion of the second piece, and thus the length of the battery frame in the vehicle width direction can be changed in accordance with the shape of the vehicle body structure by changing the shape of at least one of the first corner retainers and the second corner retainers excluding the distal end portion.

A third aspect of the present disclosure provides the battery frame structure according to the second aspect, in which: the distal end portion has one or more protrusions on a surface of the distal end portion; and the second skeleton members have long holes at positions corresponding to the one or more protrusions when the distal end portion is put into the second skeleton members, a longitudinal direction of the long holes corresponding to the vehicle width direction.

In the battery frame structure according to the third aspect of the present disclosure, the positions of the corner retainers in the vehicle width direction can be adjusted using the long holes, and thus variations in dimensions of the first skeleton members in the vehicle width direction can be absorbed.

A fourth aspect of the present disclosure provides the battery frame structure according to the second or third aspect, in which the second piece includes the distal end portion and a base portion that is greater in width than the distal end portion.

In the battery frame structure according to the fourth aspect of the present disclosure, the position in the vehicle width direction is adjusted solely by the positional relationship between the distal end portion and the second skeleton members, and thus the adjustment range in the vehicle width direction can be restricted.

As described above, with the battery frame structure according to the present disclosure, it is easier to assemble the vehicle body structure and the battery frame.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically illustrating an example of a battery frame having a battery frame structure according to an embodiment of the present disclosure;

FIG. 2 is a vertical sectional view of a side frame in FIG. 1 taken along the line II-II;

FIG. 3 is an exploded perspective view illustrating a portion of the battery frame in FIG. 1;

FIG. 4 is a perspective view schematically illustrating a mounting portion with a vehicle body structure assembled to the battery frame in FIG. 1;

FIG. 5 is a plane sectional view of the mounting portion in FIG. 4 taken along the line V-V; and

FIG. 6 is a perspective sectional view schematically illustrating a portion of a battery frame having a battery frame structure according to the related art.

### DETAILED DESCRIPTION OF EMBODIMENTS

A battery frame structure S according to an embodiment of the present disclosure will be described below with reference to the drawings. In this specification and the drawings, components having substantially the same functional configurations are denoted by the same reference numerals to omit redundant explanations. In the drawings, an arrow FR indicates the front side in the vehicle front-rear direction, and an arrow UP indicates the upper side in the vehicle up-down direction. An arrow W indicates the vehicle width direction. Hereinafter, the terms “front,” “rear,” “upper,” “lower,” “right,” and “left” refer to front and rear in the vehicle front-rear direction, upper and lower in the vehicle up-down direction, and right and left in the vehicle right-left direction (vehicle width direction), respectively, unless otherwise stated.

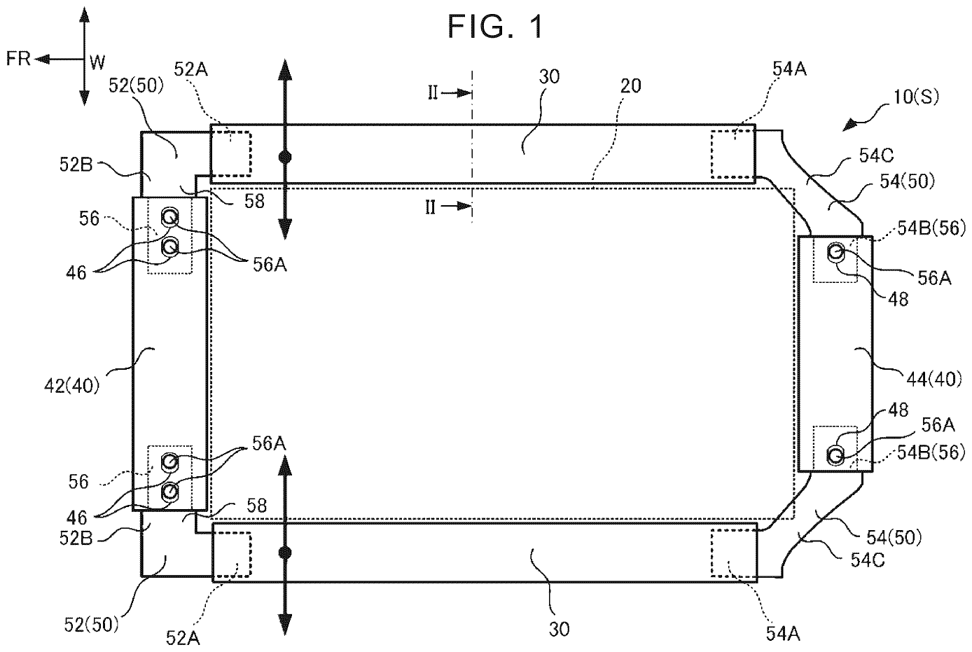

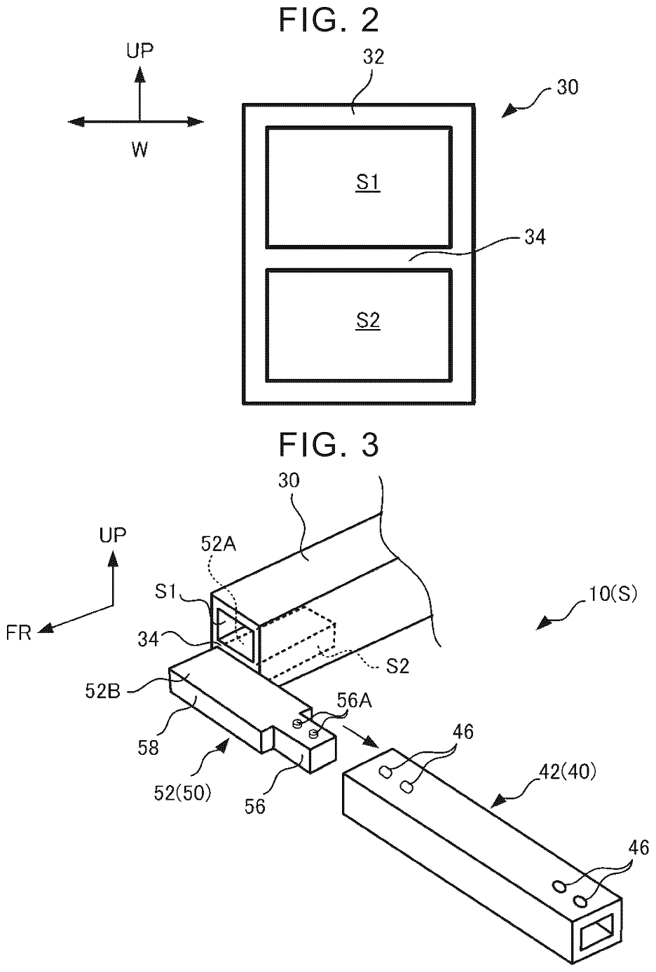

FIG. 1 is a plan view schematically illustrating an example of a battery frame 10 having a battery frame structure S according to an embodiment of the present disclosure. FIG. 2 is a plane sectional view taken along the line II-II in FIG. 1. As illustrated in FIG. 1, the battery frame 10 according to the present embodiment is a structure that supports a battery pack 20 as a battery within the frame. The battery frame 10 has a rectangular frame shape with its longitudinal direction corresponding to the vehicle front-rear direction when viewed in a plan view, for example, and includes a pair of side frames 30 as first skeleton members, a pair of cross frames 40 as second skeleton members, and corner retainers 50.

The side frames 30 extend in the vehicle front-rear direction on both outer sides of the battery pack 20 in the vehicle width direction. FIG. 2 is a vertical sectional view of the side frame 30 in FIG. 1 taken along the line II-II. The side frames 30 have a closed cross-sectional shape orthogonal to the longitudinal direction, and are formed by extrusion molding or the like using an aluminum alloy, a magnesium alloy, or the like as a material. The side frames 30 may be formed from a resin such as carbon fiber-reinforced plastic (CFRP), besides metal. Specifically, as illustrated in FIG. 2, the side frame 30 includes a main body portion 32 formed such that its cross section, when viewed from the front, is in a rectangular tube shape with its long sides corresponding to the up-down direction, by way of example, and a partition wall 34 that divides the inside of the main body portion 32 into an upper space S1 and a lower space S2 in the vehicle up-down direction.

The cross frames 40 extend in the vehicle width direction on both outer sides of the battery pack 20 in the vehicle front-rear direction. Of the cross frames 40, the frame disposed on the vehicle front side is called a front cross frame 42, and the frame disposed on the vehicle rear side is called a rear cross frame 44. In the present embodiment, the front cross frame 42 is formed to have a longer length in the vehicle width direction than the rear cross frame 44, by way of example. The cross frames 40 have a closed cross-sectional shape orthogonal to the longitudinal direction, and are formed by extrusion molding or the like using an aluminum alloy, a magnesium alloy, or the like as a material. The cross frames 40 may be formed from a resin such as carbon fiber-reinforced plastic (CFRP), besides metal.

Specifically, the cross frames 40, i.e., the front cross frame 42 and the rear cross frame 44, are formed such that their cross section, when viewed from the front, is in a rectangular tube shape with its short sides corresponding to the up-down direction, by way of example. The upper surfaces of the cross frames 40 in the vehicle up-down direction are provided with long holes 46, 48 at positions corresponding to protrusions 56A, 55 to be discussed later. Specifically, the upper surface of the front cross frame 42 is provided with two long holes 46, respectively on both sides in the longitudinal direction (vehicle width direction), side by side in the longitudinal direction, by way of example. The upper surface of the rear cross frame 44 is provided with one long hole 48, respectively on both sides in the longitudinal direction (vehicle width direction), by way of example. Each of the long holes 46, 48 is provided such that its longitudinal direction corresponds to the vehicle width direction.

The corner retainers 50 include front corner retainers 52 as first corner retainers that are used to connect the side frames 30 and the front cross frame 42, and rear corner retainers 54 as second corner retainers that are used to connect the side frames 30 and the rear cross frame 44. The front corner retainers 52 and the rear corner retainers 54 are provided on both sides in the vehicle width direction. That is, the battery frame 10 includes two front corner retainers 52 and two rear corner retainers 54.

As illustrated in FIGS. 1 and 3, the front corner retainer 52 includes a first piece 52A and a second piece 52B, and in the present embodiment, is formed in a substantially L-shape, by way of example. In the present embodiment, the second piece 52B is formed to be longer than the first piece 52A, by way of example.

Moreover, the first piece 52A is formed to correspond to the shape of the lower space S2 of the side frame 30 discussed above, and the entire first piece 52A is inserted into the lower space S2 from the vehicle front side, by way of example. The first piece 52A is fixed to the side frame 30 by a known fixing method such as an adhesive or welding, by way of example. In the present embodiment, the entire first piece 52A is inserted into the lower space S2. However, the present disclosure is not limited thereto, and only a portion of the first piece 52A on the distal end side may be inserted into the lower space S2.

The second piece 52B extends from an end portion of the first piece 52A in a direction orthogonal to the first piece 52A, and includes a distal end portion 56 and a base portion 58 that extends from the distal end portion 56 toward the first piece 52A. The base portion 58 is formed to be greater in width in the vehicle front-rear direction than the distal end portion 56, by way of example.

The distal end portion 56 is inserted into an end portion of the front cross frame 42 in the longitudinal direction, and formed to correspond to the inside diameter of the front cross frame 42. In the present embodiment, the entire distal end portion 56 is inserted inside the front cross frame 42, by way of example. In the present embodiment, the entire distal end portion 56 is inserted inside the front cross frame 42. However, the present disclosure is not limited thereto, and only a portion of the distal end portion 56 on the distal end side may be inserted inside the front cross frame 42.

Further, the distal end portion 56 includes two protrusions 56A on the surface on the vehicle upper side, i.e., on the upper surface. The protrusions 56A are cylindrical, by way of example, and the two protrusions 56A are provided side by side in the vehicle width direction. The protrusions 56A have elasticity in the vehicle up-down direction, and are fitted into the long holes 46 by being inserted inside the front cross frame 42 in a state of being contracted toward the vehicle lower side and returning (stretching) in the long holes 46. The elasticity of the protrusions 56A in the vehicle up-down direction may be achieved by using a spring member, for example, constituting the protrusions 56A themselves from an elastic material, or using any known technique. The distal end portion 56 of the second piece 52B of the front corner retainer 52 is fixed to the front cross frame 42 by fitting the protrusions 56A in the long holes 46.

As illustrated in FIG. 1, the rear corner retainer 54 includes a first piece 54A and a second piece 54B, and the first piece 54A and the second piece 54B extend from both ends of a connecting piece 54C formed in a quadrangular prism shape. Specifically, the first piece 54A and the second piece 54B extend in substantially orthogonal directions, and the connecting piece 54C is obliquely connected to the first piece 54A and the second piece 54B.

As with the first piece 52A of the front corner retainer 52 discussed above, the first piece 54A of the rear corner retainer 54 is formed to correspond to the shape of the lower space S2 of the side frame 30 discussed above, and the entire first piece 54A is inserted into the lower space S2 from the vehicle rear side, by way of example. The first piece 54A is fixed to the side frame 30 by a known fixing method such as an adhesive or welding, by way of example. In the present embodiment, the entire first piece 54A is inserted into the lower space S2. However, the present disclosure is not limited thereto, and only a portion of the first piece 54A on the distal end side may be inserted into the lower space S2.

The second piece 54B of the rear corner retainer 54 functions as a distal end portion 56 of the rear corner retainer 54, and includes one protrusion 56A on the surface on the vehicle upper side, i.e., on the upper surface. The protrusion 56A has a configuration similar to the protrusions 56A provided on the distal end portion 56 of the front corner retainer 52 discussed above, and therefore is not described in detail here.

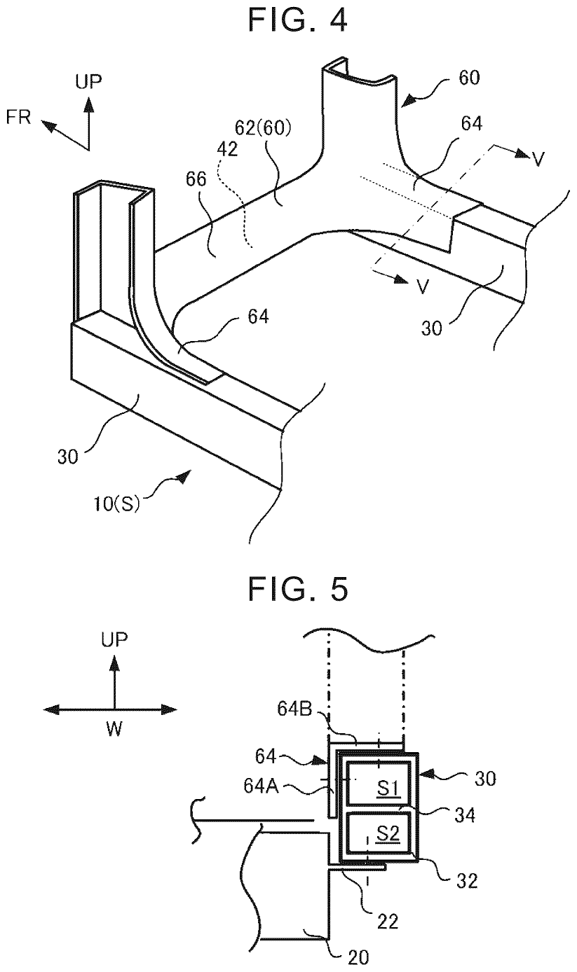

The battery pack 20 is supported on the battery frame 10 configured as described above, and a front vehicle body structure 62 (see FIG. 4) and a rear vehicle body structure (not illustrated) as a vehicle body structure 60 integrally molded by casting, by way of example, are connected to the battery frame 10 on the vehicle front side and the vehicle rear side. FIG. 4 is a perspective view schematically illustrating a mounting portion with the vehicle body structure 60 assembled to the battery frame 10 in FIG. 1. FIG. 5 is a plane sectional view of the mounting portion in FIG. 4 taken along the line V-V. FIG. 4 illustrates only a portion of the front vehicle body structure 62 including the connection points with the battery frame 10, and does not illustrate the other portions. The rear vehicle body structure can be assembled in the same manner as the front vehicle body structure 62, and therefore is not described in detail here.

As illustrated in FIG. 4, the front vehicle body structure 62 includes a pair of side member portions 64 attached so as to cover the upper and inner surfaces of the side frames 30 of the battery frame 10, and a cross member portion 66 that connects the side member portions 64. As illustrated in FIG. 5, the side member portion 64 has an open cross-sectional shape that is open on the lower and outer sides, and includes a side wall 64A that covers the inner surface of the side frame 30, and an upper wall 64B that covers the upper surface of the side frame 30. The side frame 30 is fastened to the side wall 64A and the upper wall 64B using fastening members such as bolts in two directions, that is, the vehicle up-down direction and the vehicle width direction. The side frame 30 is fastened in these two directions using walls that define the upper space S1 of the main body portion 32.

In addition, a lower wall of the side frame 30 that defines the lower space S2 of the main body portion 32 is fastened to a flange 22 provided on the battery pack 20 using a fastening member such as a bolt, by way of example. The battery frame 10 according to the present embodiment is configured to have the battery frame structure S discussed above.

### Functions and Effects

Next, the functions and effects of the first embodiment will be described.

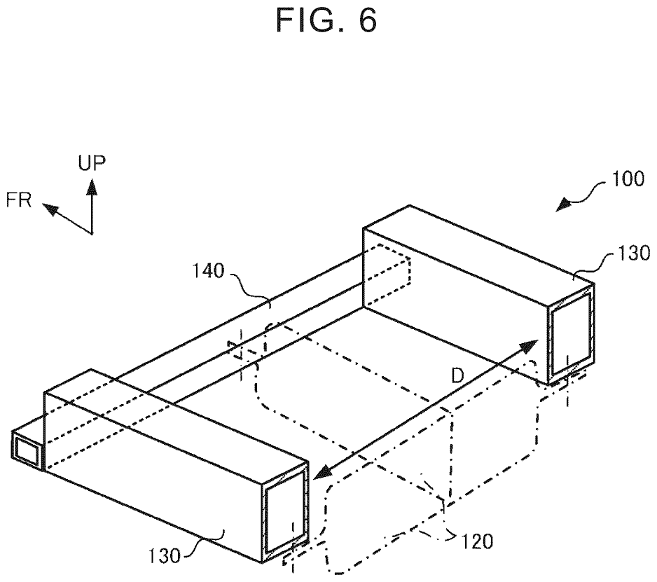

FIG. 6 is a perspective sectional view schematically illustrating a portion of a battery frame 100 having a battery frame structure according to the related art. As illustrated in FIG. 6, in the battery frame 100 having a battery frame structure according to the related art, side frames 130 have a rectangular closed cross-sectional shape, and extend in the vehicle front-rear direction on both sides in the vehicle width direction. That is, while the side frames 30 according to the above-described embodiment include the partition wall 34, the side frames 130 according to the related art do not include a partition wall.

In addition, at both ends of the battery frame 100 in the vehicle front-rear direction, cross frames 140 extend between front end portions or rear end portions of the side frames 130. The cross frames 140 are fixed to the side frames 130 on the lower side of the center of the side frames 130 in the vehicle up-down direction by welding, an adhesive, or the like, by way of example. A battery pack 120 is fixed from the lower side to the battery frame 100 thus constituted by the side frames 130 and the cross frames 140. Furthermore, on both sides of the battery frame 100 in the vehicle front-rear direction, a vehicle body structure (not illustrated) is fastened to the side frames 130 using fastening members such as bolts in two directions, that is, the vehicle up-down direction and the vehicle width direction, as in the above-described embodiment.

In the battery frame 100 according to the related art configured as described above, the cross frames 140 and the side frames 130 are fixed by welding, an adhesive, or the like as discussed above. Thus, it is difficult to achieve precision in dimension D in the vehicle width direction, which results in variations in product dimensions. When there are variations in product dimensions in this manner, a gap or interference may occur when connecting the vehicle body structure and the battery frame 100, making assembly difficult.

Thus, in the battery frame structure S of the battery frame 10 according to the present embodiment, the vehicle width direction of the right and left side frames 30 can be aligned with surfaces of the vehicle body structure 60 in the vehicle width direction by adjusting the fixed positions of the corner retainers 50 and the cross frames 40. In addition, by inserting the corner retainers 50 into the lower space S2 of the side frames 30, a step can be formed between the cross frames 40 and the side frames 30, and the vehicle body structure 60 can be joined while being aligned with the step. In this manner, in the battery frame structure S according to the present embodiment, the dimensions of the right and left side frames 30 in the vehicle width direction can be adjusted, and a step with which the vehicle body structure 60 is aligned to be joined is formed, making it easier to assemble the vehicle body structure 60 and the battery frame 10.

Furthermore, in the battery frame structure S of the battery frame 10 according to the present embodiment, the front corner retainers 52, the rear corner retainers 54, and the cross frames 40 are each fixed by the distal end portions 56, and thus the length of the battery frame 10 in the vehicle width direction can be changed in accordance with the shape of the vehicle body structure 60 by changing the shape of at least one of the front corner retainers 52 and the rear corner retainers 54 excluding the distal end portions 56.

Furthermore, in the battery frame structure S of the battery frame 10 according to the present embodiment, the positions of the corner retainers 50 in the vehicle width direction can be adjusted using the long holes 46, 48, and thus variations in dimensions of the side frames 30 in the vehicle width direction can be absorbed.

Furthermore, in the battery frame structure S of the battery frame 10 according to the present embodiment, the position in the vehicle width direction is adjusted solely by the positional relationship between the distal end portions 56 and the cross frames 40, and thus the adjustment range in the vehicle width direction can be restricted.

### Supplementary Explanation

In the above-described embodiment, the front vehicle body structure 62 mounted on the front side of the vehicle has been described as an example of the vehicle body structure. However, the present disclosure is not limited thereto. The present disclosure is also applicable to the rear vehicle body structure mounted on the rear side of the vehicle.

Furthermore, the vehicle body structure 60 according to the above-described embodiment is integrally molded by casting. However, the present disclosure is not limited thereto, and a vehicle body structure that is not integrally molded may be assembled.

In the battery frame structure S according to the above-described embodiment, the front corner retainers 52 and the rear corner retainers 54 have different shapes. However, the present disclosure is not limited thereto, and the front corner retainers 52 and the rear corner retainers 54 may have the same shape.

In addition, in the battery frame structure S according to the above-described embodiment, the holes to be fitted with the protrusions 56A are the long holes 46, 48. However, the present disclosure is not limited thereto, and the holes to be fitted with the protrusions 56A may be any hole that extends in the vehicle width direction, and may be slits, for example.

The configuration of the present disclosure is not limited to the above embodiment, and the configuration can be modified as appropriate as long as the issue can be addressed.

What is claimed is:

1. A battery frame structure comprising:
a pair of right and left first skeleton members that extends in a vehicle front-rear direction on both sides, in a vehicle width direction, of a battery for driving mounted on a vehicle, that has a closed cross-sectional shape orthogonal to a longitudinal direction, and that includes a partition wall that separates an upper space and a lower space in a vehicle up-down direction;
a pair of front and rear second skeleton members that extends in the vehicle width direction on both sides of the battery in the vehicle front-rear direction, that has a closed cross-sectional shape orthogonal to a longitudinal direction, and that is disposed on a vehicle front side or a vehicle rear side of the battery to be joined to a vehicle body structure that constitutes a vehicle body skeleton; and
corner retainers that each include a first piece and a second piece, and that are fixed with the first piece put into the lower space and with the second piece put into an end portion of the second skeleton members in the longitudinal direction.

2. The battery frame structure according to claim 1, wherein:
the corner retainers include first corner retainers that are used to connect the second skeleton member disposed on the vehicle front side and the first skeleton members, and second corner retainers that are used to connect the second skeleton member disposed on the vehicle rear side and the first skeleton members; and
the first corner retainers and the second skeleton member, and the second corner retainers and the second skeleton member, are fixed by a distal end portion of the second piece.

3. The battery frame structure according to claim 2, wherein:
the distal end portion has one or more protrusions on a surface of the distal end portion; and
the second skeleton members have long holes at positions corresponding to the one or more protrusions when the distal end portion is put into the second skeleton members, a longitudinal direction of the long holes corresponding to the vehicle width direction.

4. The battery frame structure according to claim 2, wherein the second piece includes the distal end portion and a base portion that is greater in width than the distal end portion.
